(19) United States
(12) Patent Application Publication
(10) Pub. No.: US 2014/0290077 A1
(43) Pub. Date: Oct. 2, 2014

(54) Seal Cutter

(71) Applicant: Jay Paulson, Redmond, WA (US)

(72) Inventor: Jay Paulson, Redmond, WA (US)

(21) Appl. No.: 13/937,120

(22) Filed: Jul. 8, 2013

Related U.S. Application Data
(60) Provisional application No. 61/807,209, filed on Apr. 1, 2013.

(51) Int. Cl. B67B 7/46

(52) U.S. Cl. CPC B67B 7/30
USPC 30/400

(57) ABSTRACT

The instant application discloses, among other things, a Seal Cutter, which may allow a user to cut along the inner edge of the seal on a container, for example, a food jar, for easy removal of the seal and access to the container's contents. In one embodiment, the Seal Cutter may comprise a handle configured to fit within the user's hand. It may have a blade, or other cutting device, attached to the bottom surface of the handle. The Seal Cutter may also have a housing compartment which may hold an elongated plunger and a spring. When the user presses the plunger face plate against the edge of a container, the blade may become exposed and may be used to cut along the inner edge of the container's seal for easy removal.

### FIELD

This disclosure relates generally to cutting tools, and more particularly, a Seal Cutter.

### BACKGROUND

Seals on containers such as food jars or medicine bottles, for example, are often difficult to remove. Many consumers use a knife or other sharp object to puncture the seal, putting themselves at risk of getting cut. Consumers are also left with jagged, and often messy, pieces of plastic or aluminum which they must peel off of the rim of the container to access its contents. Even if the seal has a pulling tab, people must often expend great time and effort grasping the tab and detaching the seal from the container. Such a task may be particularly difficult for people with limited fine motor strength, such as arthritis patients and the elderly.

### SUMMARY

The instant application discloses, among other things, a Seal Cutter, which may allow a user to cut along the inner edge of the seal on a container, for example, a food jar, for easy removal of the seal and access to the container's contents. In one embodiment, the Seal Cutter may comprise a handle configured to fit within the user's hand. It may have a blade, or other cutting device, attached to the bottom surface of the handle. The blade or cutting device may be blocked when the invention is not in use and become exposed when it is in use.

The Seal Cutter may also have a housing compartment attached to the bottom surface of the handle. The compartment may hold an elongated plunger and a spring. The first end of the plunger may have a face plate located in between the blade and the compartment. The face plate may couple to a cylindrical rod capable of sliding in and out of the compartment and compressing and expanding the spring.

The face plate may press against a flat side of the blade when the Seal Cutter is in “resting” position, blocking the blade when the invention is not in use. When pressure is placed against the face plate, for example, when the user presses the face plate against the edge container, the blade may become exposed. The user may press the Seal Cutter in one downward motion, so as to allow the blade to slice into the container's inner seal. The user may then rotate the container, allowing the blade to cut along the inner edge of the seal for easy removal.

A person having skill in the art will recognize that the Seal Cutter and its components may be made of any material such as plastic, silicone, rubber, wood, metal, or carbon fiber, for example. A Seal Cutter may also be made in various shapes and sizes to accommodate different user characteristics and container types.

Many of the attendant features may be more readily appreciated as they become better understood by reference to the following detailed description considered in connection with the appended drawings.

### BRIEF DESCRIPTION OF THE DRAWINGS

FIG. 1 is a perspective view of a Seal Cutter shown in use, according to one embodiment.

FIG. 2 is a top perspective view of a Seal Cutter, according to one embodiment.

FIG. 3 is a bottom perspective view of a Seal Cutter illustrated with the Plunger in a non-retracted, “resting” position, according to one embodiment.

FIG. 4 is a bottom perspective view of a Seal Cutter illustrated with the Plunger in a retracted configuration, according to one embodiment.

FIG. 5 is a cross-section view of a Seal Cutter, according to one embodiment.

FIG. 6 is a cross-section view of a Seal Cutter in use, according to one embodiment.

### DETAILED DESCRIPTION

A more particular description of certain embodiments of Smart Tiles may be had by references to the embodiments shown in the drawings that form a part of this specification, in which like numerals represent like objects.

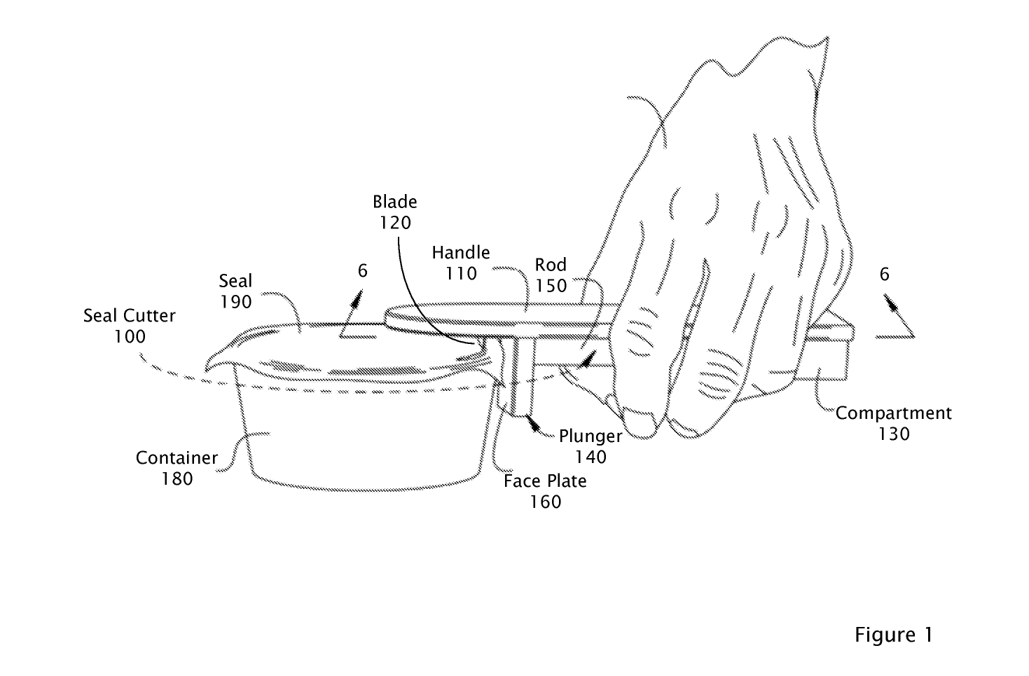

FIG. 1 illustrates a perspective view of a Seal Cutter 100 shown in use, according to one embodiment. Seal Cutter 100 may comprise a Handle 110 which may be configured to fit within a User's Hand 170. Handle 110 may have a Blade 120 attached to its bottom surface. Blade 120 may generally comprise a triangular shape, or any other shape.

Seal Cutter 100 may also have a Compartment 130 which houses an elongated Plunger 140 and a Spring 510. The first end of Plunger 140 may have a Face Plate 160, which may be located in between Blade 120 and Compartment 130. Face Plate 160 may couple with the first end of a Plunger Rod 150. Plunger Rod 150 may be in the shape of a cylinder, or any other shape, and fit within an interior chamber of Compartment 130. The second end of Plunger Rod 150 may press against Spring 510 inside the chamber.

When pressure is put on Face Plate 160, for example, when the user presses it against the side of Container 180, Plunger Rod 150 may slide into the interior chamber of Compartment 130 and compress Spring 510. When pressure is released from Face Plate 160, for example, when the user moves Plunger Rod 150 away from Container 180, or when the invention is in its “resting” position, Spring 510 may expand, and a portion of the Plunger Rod 150 may slide out of Compartment 130.

Plunger Face Plate 160 may push against Blade 120 when the Seal Cutter 100 is not in use, or in its “resting” position, and may block Blade 120, which may make it less likely that Blade 120 may cut or puncture something inadvertently. When in use, the user may press the invention into the Seal 190 of the Container 180, and rotate Container 180 so as to allow Blade 120 to cut along the inner edge of the Seal 190.

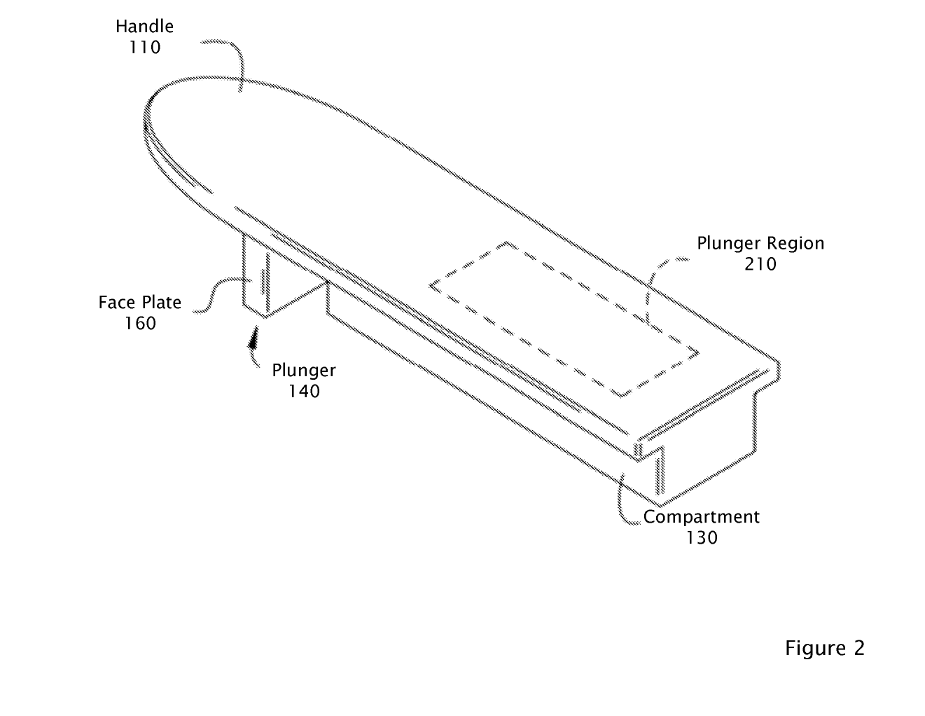

FIG. 2 illustrates a top perspective view of a Seal Cutter with Plunger Region 210.

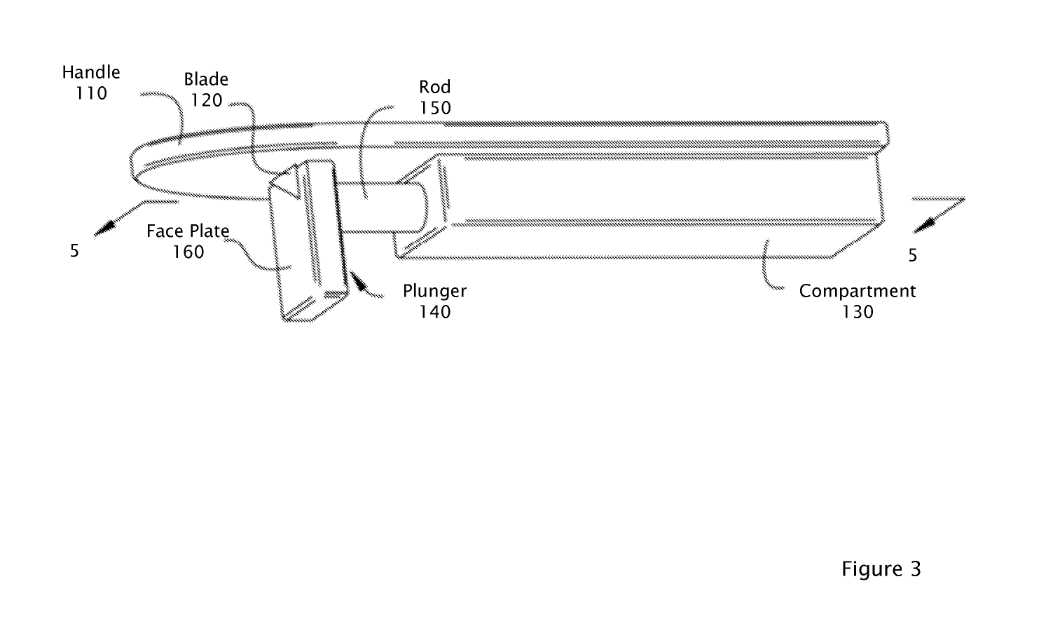

FIG. 3 is a bottom perspective view of a Seal Cutter illustrated with the Plunger 140 in a non-retracted, “resting” position, according to one embodiment.

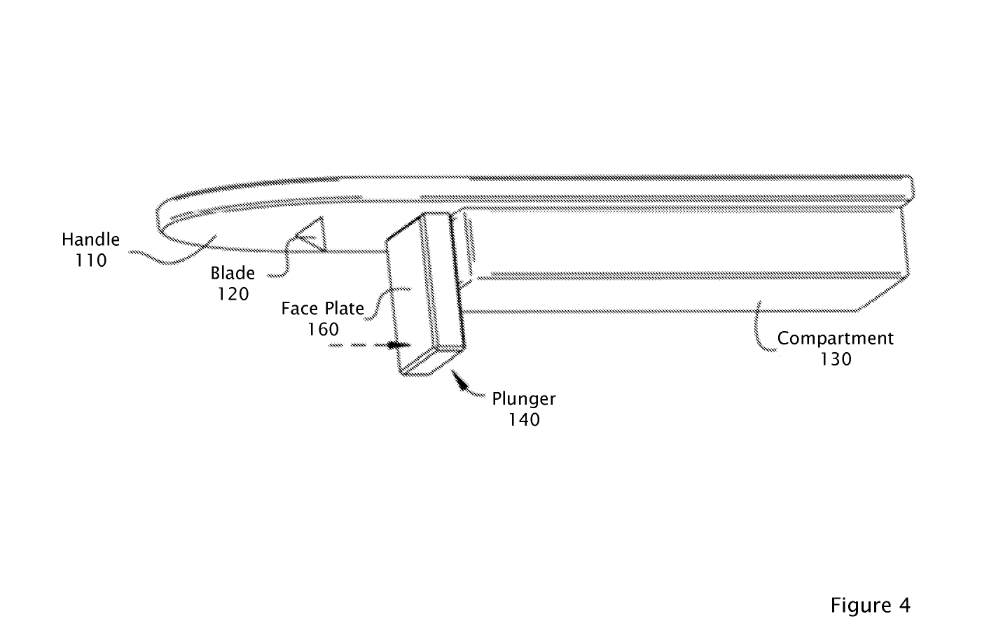

FIG. 4 is a bottom perspective view of a Seal Cutter illustrated with the Face Plate 160 in a retracted configuration, according to one embodiment.

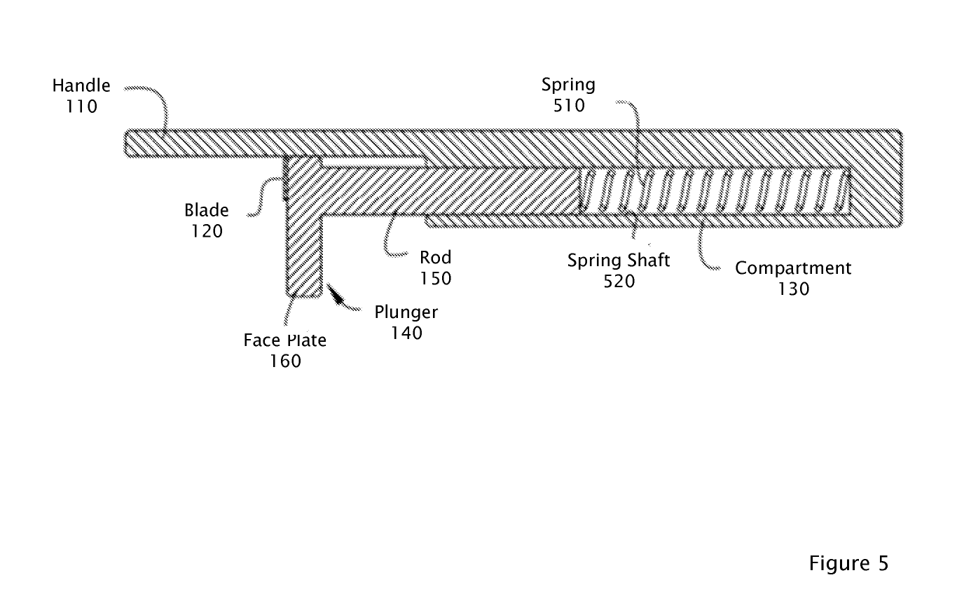

FIG. 5 illustrates a cross-section view of a Seal Cutter, according to one embodiment. When pressure is released from Face Plate 160, Spring 510 may expand within Spring Shaft 520, and a portion of the Plunger Rod 150 may slide out of Compartment 130.

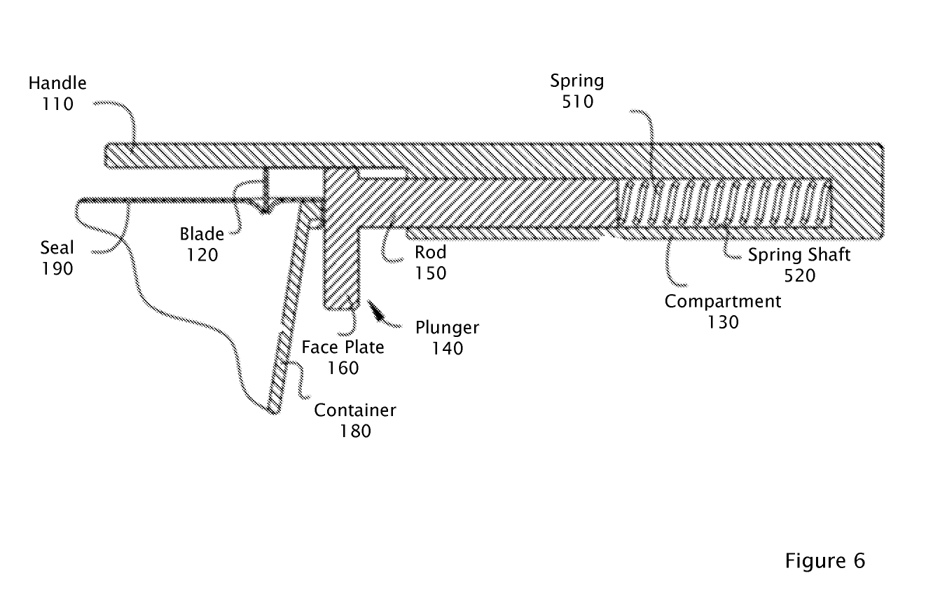

FIG. 6 illustrates a cross-section view of a Seal Cutter 100, according to one embodiment. When pressure is put on Face Plate 160, Plunger Rod 150 may slide into the interior chamber of Compartment 130 and compress Spring 510 in Spring Shaft 520, exposing Blade 120. The user may then move the Seal Cutter in one downward motion and rotate Container 180 to allow the blade to slice along the inner edge of Seal 190.

One having skill in the art will recognize that many different designs of Container Seal Sutter may fall within the spirit and scope of this disclosure, including, for example, various colors, sizes, and shapes, and comprised of various materials.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description may show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data may not provide a complete description of the manufacture and use of the invention. Since many embodiments of the invention can be made without departing from the spirit and scope of the invention, the invention resides in the claims hereinafter appended.

1. A seal cutter, comprising:
a handle, having top and bottom surface, the bottom surface comprising:
a blade, the blade fixedly attached to the bottom surface of the handle;
a compartment fixedly attached to the bottom surface of the handle, the compartment housing a plunger and spring, the plunger having a face plate on its first end end and touching the spring on its second end.

2. The seal cutter of claim 1 wherein the blade is blocked when the device is not in use.

3. The seal cutter of claim 1 wherein the blade is generally a triangular shape;

4. The seal cutter of claim 1 wherein the handle is made from one or more materials selected from the group containing plastic, silicone, rubber, wood, metal, or carbon fiber.
